(19) United States
(12) Patent Application Publication
(10) Pub. No.: US 2025/0068000 A1
(43) Pub. Date: Feb. 27, 2025

(54) APPARATUS AND METHOD OF IMPROVING RETINAL IMAGE QUALITY WITH A SLOTTED TRANSMISSIVE REGION

(71) Applicant: UNIVERSITY OF HOUSTON SYSTEM, Houston, TX (US)

(72) Inventor: Geunyoung Yoon, Houston, TX (US)

(73) Assignee: UNIVERSITY OF HOUSTON SYSTEM, Houston, TX (US)

(21) Appl. No.: 18/808,389

(22) Filed: Aug. 19, 2024

Related U.S. Application Data
(60) Provisional application No. 63/534,749, filed on Aug. 25, 2023.

(51) Int. Cl. G02C 7/02; G02C 7/04

(52) U.S. Cl. CPC G02C 7/022; G02C 7/04; G02C 2202/04

(57) ABSTRACT

A corrective lens for correcting aberrations of an eye of a patient includes a central region formed in the center of the corrective lens preventing light transmission. The corrective lens further includes a slotted transmissive region formed in the central region, the slotted transmissive region allowing light transmission therethrough.

### CROSS-REFERENCE TO RELATED APPLICATIONS

This application claims priority to and the benefit of U.S. Provisional Patent Application Ser. No. 63/534,749, filed Aug. 25, 2023, which is incorporated herein by reference in its entirety.

### FIELD OF THE INVENTION

The present invention relates generally to a corrective lens for correction of eye disorders, and more specifically, to a corrective lens with a slotted transmissive region for improving retinal image quality in highly aberrated eyes.

### BACKGROUND OF THE INVENTION

It has long been known that the eye's optical defects, i.e., aberrations degrade visual performance especially under dim light conditions where the eye pupil size increases. The degradation becomes even more dominant in highly aberrated eyes with irregular cornea such as keratoconus and post-refractive surgery ectasia. These aberrations cannot be corrected with conventional spectacles of contact lenses especially in moderate to severe pathologic cases. The wavefront-guided or customized specialty contact lenses can be an effective approach to overcoming the problem, however many of these options are still under development for commercialization and the requirement of full customization increases the cost. The other limitation of wavefront-guided contact lenses is that the correction performance significantly depends on positional stability of the lens.

The present disclosure provides a solution for these and other problems.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a corrective lens for correcting aberrations of an eye of a patient is disclosed. The corrective lens includes a central region formed in the center of the corrective lens preventing light transmission. The corrective lens further includes a slotted transmissive region formed in the central region, the slotted transmissive region allowing light transmission therethrough.

According to certain aspects of the present disclosure, the slotted transmissive region is formed in the center of the central region.

According to certain aspects of the present disclosure, the slotted transmissive region is formed spaced from the center of the central region.

According to certain aspects of the present disclosure, the lens improves depth of focus to improve retinal image quality of objects that are at far, intermediate, and near distances from the eye.

According to certain aspects of the present disclosure, the lens is one of a soft contact lens, hard contact lens, spectacles, and an intraocular lens.

According to certain aspects of the present disclosure, the corrective lens has an orientation when worn on the eye, and the slotted transmissive region is elongated in a horizontal direction relative to the orientation of the corrective lens when worn.

According to certain aspects of the present disclosure, the corrective lens has an orientation when worn on the eye, and the slotted transmissive region is elongated in a vertical direction relative to the orientation of the corrective lens when worn.

According to certain aspects of the present disclosure, the corrective lens has an orientation when worn on the eye, and the slotted transmissive region is elongated in a diagonal direction relative to the orientation of the corrective lens when worn.

According to certain aspects of the present disclosure, the slotted transmissive region has non-parallel long sides.

According to certain aspects of the present disclosure, the slotted transmissive region has curvilinear long sides.

According to certain aspects of the present disclosure, the central region is printed onto a surface of the corrective lens.

According to certain aspects of the present disclosure, the slotted transmissive region includes an aperture disposed through the corrective lens.

According to certain aspects of the present disclosure, the central region includes an opaque pigment in a material of the corrective lens, the aperture being formed subsequent to the opaque pigment being added.

According to certain aspects of the present disclosure, the aperture is formed through the corrective lens with a laser.

According to certain aspects of the present disclosure, corrective lenses for correcting aberrations of eyes of a patient are disclosed. The corrective lenses include a first corrective lens and a second corrective lens. A first central region is formed in the center of the first corrective lens, the first central region preventing light transmission. A second central region is formed in the center the second corrective lens, the second central region preventing light transmission. A first slotted transmissive region is formed in the first central region, the first slotted transmissive region allowing light transmission therethrough. A second slotted transmissive region is formed in the second central region, the second slotted transmissive region allowing light transmission therethrough.

According to certain aspects of the present disclosure, the first corrective lens has a first orientation when worn on a first eye, and the second corrective lens has a second orientation when worn on a second eye. The first slotted transmissive region is elongated in a first direction relative to the orientation of the first corrective lens when worn, the second slotted transmissive region is elongated in a second direction relative to the orientation of the second corrective lens when worn, and the first direction is different from the second direction.

According to other aspects of the present disclosure, the first slotted transmissive region formed in the first central region has a first shape, the second slotted transmissive region formed in the second central region has a second shape, and the first shape is different from the second shape.

According to some aspects of the present disclosure, at least one of the first slotted transmissive region and the second slotted transmissive region is formed in the center of the respective first and second central regions.

According to some aspects of the present disclosure, both the first slotted transmissive region and the second slotted transmissive region are formed in the center of the respective first and second central regions.

According to yet other aspects of the present disclosure, a method is directed to correcting aberrations of an eye. The method includes positioning a corrective lens to an eye. The corrective lens has a central region formed in the center of the corrective lens, the central region preventing light transmission. The corrective lens further has a slotted transmissive region formed in the central region allowing light transmission therethrough.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments and are therefore not to be considered as limitations on the scope of the various embodiments or claims.

FIG. 1 is a schematic plan view of an exemplary corrective lens showing a slotted transmissive region formed in the center of a central region, and being elongated in a horizontal direction relative to the orientation of the corrective lens when worn, according to certain aspects of the present disclosure.

FIG. 2 is a schematic plan view of another exemplary corrective lens showing a slotted transmissive region formed spaced from the center of the central region, and being elongated in the horizontal direction relative to the orientation of the corrective lens when worn, according to certain aspects of the present disclosure.

FIG. 3 is a schematic plan view of an exemplary corrective lens showing a slotted transmissive region formed in the center of the central region, and being elongated in a vertical direction relative to the orientation of the corrective lens when worn, according to certain aspects of the present disclosure.

FIG. 4 is a schematic plan view of another exemplary corrective lens showing a slotted transmissive region formed spaced from the center of the central region, and being elongated in the vertical direction relative to the orientation of the corrective lens when worn, according to certain aspects of the present disclosure.

FIG. 5 is a schematic plan view of an exemplary corrective lens showing a slotted transmissive region formed in the center of the central region, and being elongated in a diagonal direction relative to the orientation of the corrective lens when worn, according to certain aspects of the present disclosure.

FIG. 6 is a schematic plan view of another exemplary corrective lens showing a slotted transmissive region formed spaced from the center of the central region, and being elongated in a diagonal direction relative to the orientation of the corrective lens when worn, according to certain aspects of the present disclosure.

FIG. 7 is a schematic representation of exemplary geometry of a slotted transmissive region, according to certain aspects of the present disclosure.

FIG. 8 is a schematic plan view of an exemplary corrective lens showing a slotted transmissive region having the shape of a rounded rectangle, formed in the center of the central region, and being elongated in a diagonal direction relative to the orientation of the corrective lens when worn, according to certain aspects of the present disclosure.

FIG. 9 is a schematic plan view of an exemplary corrective lens showing a slotted transmissive region having non-parallel long sides, formed spaced from the center of the central region, and being elongated in a diagonal direction relative to the orientation of the corrective lens when worn, according to certain aspects of the present disclosure.

FIG. 10 is a schematic plan view of an exemplary corrective lens showing a slotted transmissive region having an irregular shape, formed spaced from the center of the central region, and being elongated in a diagonal direction relative to the orientation of the corrective lens when worn, according to certain aspects of the present disclosure.

FIG. 11 is a schematic plan view of a set of an exemplary corrective lenses each including a slotted transmissive region having different parameters for size, shape, position, and orientation relative to the orientation of the corrective lens when worn, according to certain aspects of the present disclosure.

FIG. 12A illustrates simulated retinal image quality for an eye having aberration and coma provided by a lens having a circular aperture without and with defocus and astigmatism optimization, according to certain aspects of the present disclosure.

FIG. 12B illustrates simulated retinal image quality for an eye having aberration and coma provided by a lens having a slotted transmissive region oriented horizontally relative to the orientation of the corrective lens when worn, without and with defocus and astigmatism optimization, according to certain aspects of the present disclosure.

FIG. 12C illustrates simulated retinal image quality for an eye having aberration and coma provided by a lens having a slotted transmissive region oriented vertically relative to the orientation of the corrective lens when worn, without and with defocus and astigmatism optimization, according to certain aspects of the present disclosure.

FIG. 13A illustrates simulated retinal image quality for an eye having aberration and coma subjected to an applied defocus of minus 1 D for lens having a circular aperture, a slotted transmissive region oriented horizontally relative to the orientation of the corrective lens when worn, and a slotted transmissive region oriented vertically relative to the orientation of the corrective lens when worn, according to an aspect of the present disclosure.

FIG. 13B illustrates simulated retinal image quality for an eye having aberration and coma subjected to an applied defocus of minus 0.75 D for lens having a circular aperture, a slotted transmissive region oriented horizontally relative to the orientation of the corrective lens when worn, and a slotted transmissive region oriented vertically relative to the orientation of the corrective lens when worn, according to an aspect of the present disclosure.

FIG. 13C illustrates simulated retinal image quality for an eye having aberration and coma subjected to an applied defocus of minus 0.5 D for lens having a circular aperture, a slotted transmissive region oriented horizontally relative to the orientation of the corrective lens when worn, and a slotted transmissive region oriented vertically relative to the orientation of the corrective lens when worn, according to an aspect of the present disclosure.

FIG. 13D illustrates simulated retinal image quality for an eye having aberration and coma subjected to an applied defocus of minus 0.25 D for lens having a circular aperture, a slotted transmissive region oriented horizontally relative to the orientation of the corrective lens when worn, and a slotted transmissive region oriented vertically relative to the orientation of the corrective lens when worn, according to an aspect of the present disclosure.

FIG. 13E illustrates simulated retinal image quality for an eye having aberration and coma subjected to an applied defocus of 0 D for lens having a circular aperture, a slotted transmissive region oriented horizontally relative to the orientation of the corrective lens when worn, and a slotted transmissive region oriented vertically relative to the orientation of the corrective lens when worn, according to an aspect of the present disclosure.

FIG. 13F illustrates simulated retinal image quality for an eye having aberration and coma subjected to an applied defocus of 0.25 D for lens having a circular aperture, a slotted transmissive region oriented horizontally relative to the orientation of the corrective lens when worn, and a slotted transmissive region oriented vertically relative to the orientation of the corrective lens when worn, according to an aspect of the present disclosure.

FIG. 13G illustrates simulated retinal image quality for an eye having aberration and coma subjected to an applied defocus of 0.5 D for lens having a circular aperture, a slotted transmissive region oriented horizontally relative to the orientation of the corrective lens when worn, and a slotted transmissive region oriented vertically relative to the orientation of the corrective lens when worn, according to an aspect of the present disclosure.

FIG. 13H illustrates simulated retinal image quality for an eye having aberration and coma subjected to an applied defocus of 0.75 D for lens having a circular aperture, a slotted transmissive region oriented horizontally relative to the orientation of the corrective lens when worn, and a slotted transmissive region oriented vertically relative to the orientation of the corrective lens when worn, according to an aspect of the present disclosure.

FIG. 13I illustrates simulated retinal image quality for an eye having aberration and coma subjected to an applied defocus of 1 D for lens having a circular aperture, a slotted transmissive region oriented horizontally relative to the orientation of the corrective lens when worn, and a slotted transmissive region oriented vertically relative to the orientation of the corrective lens when worn, according to an aspect of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

The primary goal of any corrective measure is to correct the vision of a person to compensate for optical defects of the eye, known as aberrations. Corrective measures include, for example, contact lenses, including soft contact lenses (SCL), hard contact lenses, eyeglasses, and surgical interventions. Hard contact lenses include, for example, rigid gas permeable, scleral lens (small and large diameter), and an intraocular lens.

The present disclosure is directed toward an example method that improves retinal image quality to reduce the impact of aberrations of the eye to improve visual performance. The eye's aberration increases with the eye's pupil size i.e., the smaller the pupil diameter, the better the retinal image quality. Therefore, using a very small circular pinhole is an effective way to reduce the effects of the aberrations, but considerable loss in the amount of light entering the eye is a serious concern especially under dark visual environment conditions.

The present disclosure addresses this and other problems. An example method uses a slit pinhole in the form of a slotted transmissive region that increases the amount of the light entering the eye while maintaining the pinhole effect, i.e., reducing the aberration effects. Making the pinhole a slotted shape, i.e., giving the pinhole an elongated shape to make it larger generally along a first axis helps to add more light entering the eye. Making the pinhole a slotted shape also maintains the benefit of the pinhole effect in the thin dimension of the slotted shape, which provides an increased depth of focus in the direction of a second axis orthogonal to the first axis. This means that the orientation of the slotted transmissive region is a useful parameter for use in the reduction of the effects of aberrations, and can be tailored to meet the needs of a patient's eye. Similar to the orientation of the slotted transmissive region, the position, shape, and dimensions of the slotted transmissive region are all useful parameters that can be adjusted for a patient's eye to reduce the effects of aberrations.

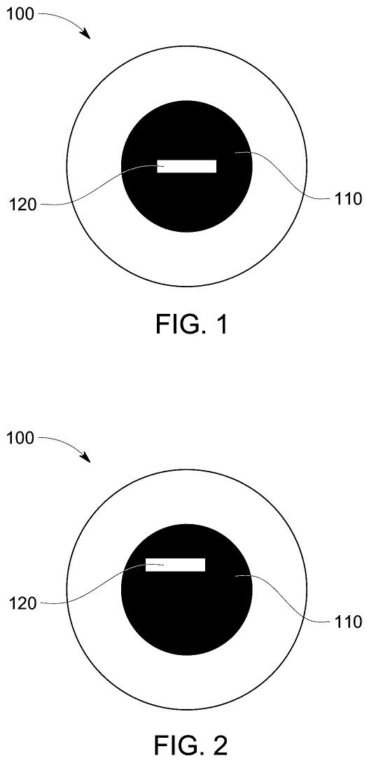

The slotted transmissive region is implemented into a contact lens (soft and hard), spectacles and potentially an intraocular lens. As noted, this could also be effective in extending depth of focus, resulting in improving near vision in these patients suffering from presbyopia (age-related near vision loss). Thus, a corrective lens implementing the slotted transmissive region improves depth of focus to improve retinal image quality of objects that are at far, intermediate and near distances from the eye. It should be noted that the corrective lens 100 as described herein has an orientation when seated on or worn on a patient's eye. Orientation of features of the corrective lens 100 are shown in the various drawings (e.g., FIGS. 1-11) and described relative to the orientation of the corrective lens 100 as worn on the patient's eye.

Referring generally to FIGS. 1 and 2, an exemplary corrective lens 100 is shown including an opaque central region 110 formed in the center of the corrective lens 100 and preventing light transmission. The corrective lens 100 also includes a slotted transmissive region 120 formed in the central region 110, where the slotted transmissive region 120 allows light transmission therethrough. The slotted transmissive region 120 is elongated in a horizontal direction relative to the orientation of the corrective lens 100 when worn.

In an embodiment the light transmissive region 120 is a transparent portion 120 of the corrective lens 100. In another embodiment the light transmissive region 120 is an aperture 120 disposed through the corrective lens 100. Such an aperture 120 could be implemented into the corrective lens 100, for example, a contact lens (soft or hard), spectacles, or an intraocular lens. The central region 110 is shown in FIGS. 1 and 2 to be circular; however the central region 110 can, for example be other shapes, including without limitation elliptical, oval, rectangular, and rounded rectangular.

Referring in particular to FIG. 1, in an embodiment, the slotted transmissive region 120 is formed in the center of the central region 110. Referring in particular to FIG. 2, in another embodiment, the slotted transmissive region 120 is formed off-center or spaced from the center of the central region 110. The position of the slotted transmissive region 120 relative to the center of the central region 110 is an adjustable parameter for use in reducing the effects of aberrations for a patient's eye.

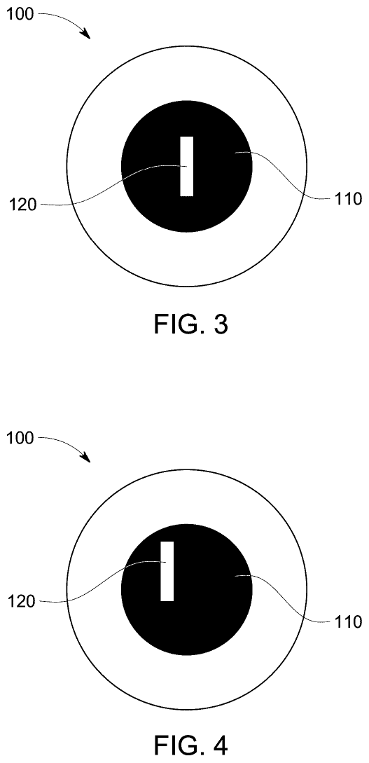

Referring generally to FIGS. 3 and 4, the corrective lens 100 includes the exemplary slotted transmissive region 120 being elongated in a vertical direction relative to the orientation of the corrective lens 100 when worn. The orientation of the slotted transmissive region 120 relative to the orientation of the corrective lens 100 when worn is an adjustable parameter for use in reducing the effects of aberrations for a patient's eye. Referring in particular to FIG. 3, in an embodiment, the slotted transmissive region 120 is formed in the center of the central region 110. Referring in particular to FIG. 4, in another embodiment, the slotted transmissive region 120 is formed off-center or spaced from the center of the central region 110.

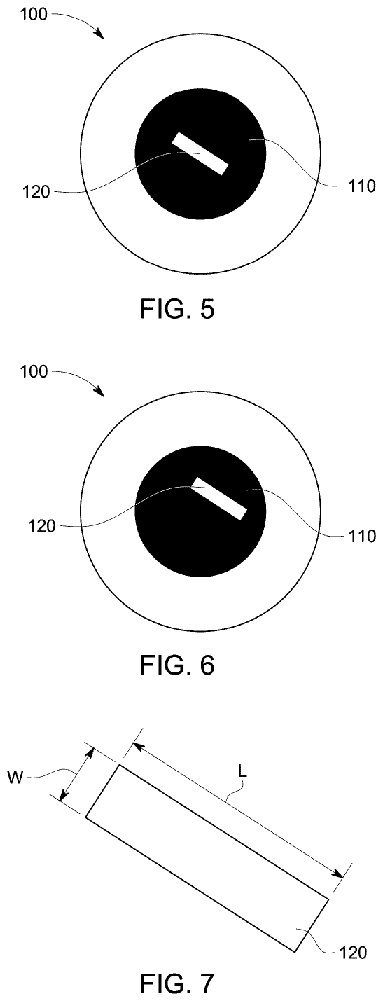

Referring generally to FIGS. 5 and 6, the corrective lens 100 includes the exemplary slotted transmissive region 120 being elongated in a diagonal direction relative to the orientation of the corrective lens 100 when worn. Referring in particular to FIG. 5, in an embodiment, the slotted transmissive region 120 is formed in the center of the central region 110. Referring in particular to FIG. 6, in another embodiment, the slotted transmissive region 120 is formed off-center or spaced from the center of the central region 110.

Referring to FIG. 7, the slotted transmissive region 120 illustrated in FIGS. 1-6 is rectangular having parallel long sides of length L and parallel short sides of width W. For example, the length L is in a range of about 3 millimeters (mm) to about 6 mm, and the width W is in a range of about 1 mm to about 2 mm. The length L and the width W of the slotted transmissive region 120 are adjustable parameters for use in reducing the effects of aberrations for a patient's eye, and can be adjusted as needed for the needs of a particular patient.

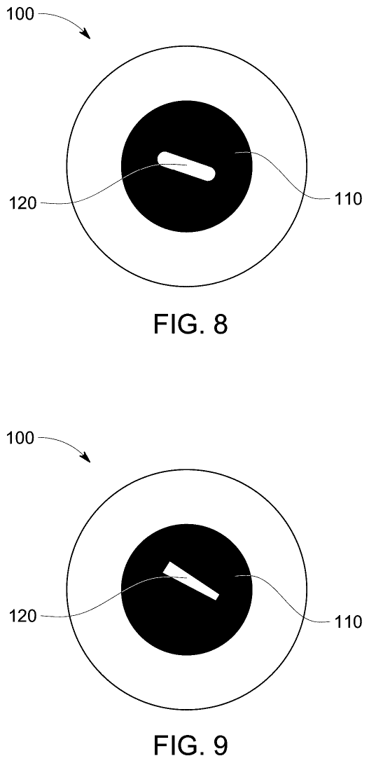

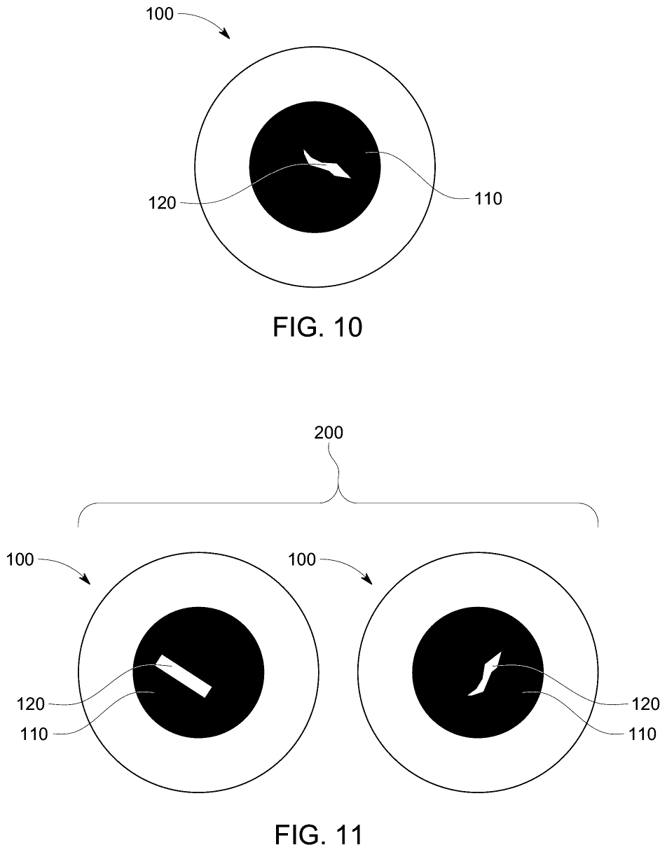

Although shown as rectangular in FIGS. 1-7, the slotted transmissive region 120 in some embodiments has a shape other than rectangular, for example having parallel or non-parallel long or short sides and including without limitation, elliptical, oval, rounded rectangular, trapezoidal, or irregularly shaped. Like the position, orientation, and size of the slotted transmissive region 120 as noted above, the shape of the slotted transmissive region 120 is another adjustable parameter for use in reducing the effects of aberrations for a patient's eye. Referring to FIG. 8, for example, the slotted transmissive region 120 is illustrated to be a rounded rectangle. Referring to FIG. 9, for example, the slotted transmissive region 120 has a generally trapezoidal shape having non-parallel long sides. Referring to FIG. 10, for example, the slotted transmissive region 120 is an irregular shape having non-parallel curvilinear long sides and no short sides.

It is of note that the slotted transmissive region 120 of FIG. 10 is, for example, also de-centered relative to the central region 110 and elongated in a diagonal direction relative to the orientation of the corrective lens 100 when worn. It is observed that there are too many possible combinations of the parameters of size, shape, orientation, and position for the slotted transmissive region 120 to be shown in the drawings. It should therefore be noted that any parameter of size, shape, orientation, or position for the slotted transmissive region 120 as described herein and shown in the FIGS. can be combined with any other parameter of size, shape, orientation, or position as needed or desired.

The human brain combines the images received through both eyes into a single binocular image. Referring to FIG. 11 in an embodiment a set 200 of corrective lenses 100 is illustrated. For example, each of the corrective lenses 100 includes a slotted transmissive region 120 combining any of the parameters for size, shape, orientation, or position as described hereinabove. The set 200 of the corrective lenses 100 each having the slotted transmissive region 120 produces binocular vision that reduces the effects of aberrations for a patient's eyes. The corrective lenses 100 of the set 200 can include slotted transmissive regions 120 having the same or different parameters for size, shape, orientation, or position of the slotted transmissive regions 120 as illustrated in FIG. 11.

In an exemplary embodiment, a method of correcting aberrations of an eye includes positioning a corrective lens 100 (FIGS. 1-6 and 8-11) to an eye. The corrective lens 100 includes a central region 110 (FIGS. 1-6 and 8-11) formed in the center of the corrective lens 100. The central region 110 prevents light transmission. A slotted transmissive region 120 is formed in the central region 110.

In another exemplary embodiment, the corrective lens 100 (including any embodiment of the slotted transmissive region 120 described hereinabove) is manufactured by printing the central region 110 onto a surface of the corrective lens 100. In yet another exemplary embodiment, the corrective lens 100 is manufactured by including an opaque pigment in material of the central region 110 while not including the opaque pigment in material of the slotted transmissive region 120. In yet another exemplary embodiment, the corrective lens 100 is manufactured by including an opaque pigment in material of at least the central region 110 of the corrective lens 100, and subsequently forming the slotted transmissive region 120 as an aperture 120 through the corrective lens 100. The aperture 120 is formed through the corrective lens 100, for example without limitation, with a laser. The structure described herein for the corrective lens 100 is applicable to any of a soft contact lens, a hard contact lens, a spectacle lens, and an intraocular lens.

According to various embodiments, the corrective lens 100 for reducing the effects of aberrations as described hereinabove is manufactured using any suitable materials by mechanical machining means, such as by use of lathes, milling machines (typically computer numerical control milling (CNC)), etc. Other suitable manufacturing techniques include laser manufacturing techniques. Exemplary suitable laser manufacturing and forming techniques include the blue intra-tissue refractive index shaping (Blue-IRIS). Suitable materials include any suitable plastic, glass, including any suitable contact lens materials.

Software for modeling and creating the structures (e.g., lens patterns to be written by laser or milled by machines) for writing or machining the structures described hereinabove to optical devices (e.g., eyeglass lenses, contact lenses, the cornea of the human eye) can be provided on a computer readable non-transitory storage medium. A computer readable non-transitory storage medium as non-transitory data storage includes any data stored on any suitable media in a non-fleeting manner Such data storage includes any suitable computer readable non-transitory storage medium, including, but not limited to hard drives, non-volatile RAM, SSD devices, CDs, DVDs, etc.

The central region 110 and the slotted transmissive region 120 disclosed herein are provided by either printing a pattern on the surface of the corrective lens 100, using an inkjet printing process for the pattern, or depositing a color pigment into the clear material of the corrective lens 100, and forming the slotted transmissive region 120 in the color pigment. In the example of an inkjet printer, the pattern is printed on corrective lens 100 positioned on a carrier based on a graphic image stored on a computer that controls the inkjet printer. Applications executed on the computer are optionally or alternatively used to provide the shape, size, position, and/or orientation of the slotted transmissive region 120, including any of the embodiments described above, as well as the size of the central region 110. As noted above, the position of the slotted transmissive region 120 can be decentered slightly from the geometric center of the corrective lens 100 depending on the position of the corrective lens 100 on eye relative to the pupil center of the eye, and other factors. As further noted, slotted transmissive region 120 can be elongated vertically, diagonally, or horizontally relative to the orientation of the corrective lens 100 when worn.

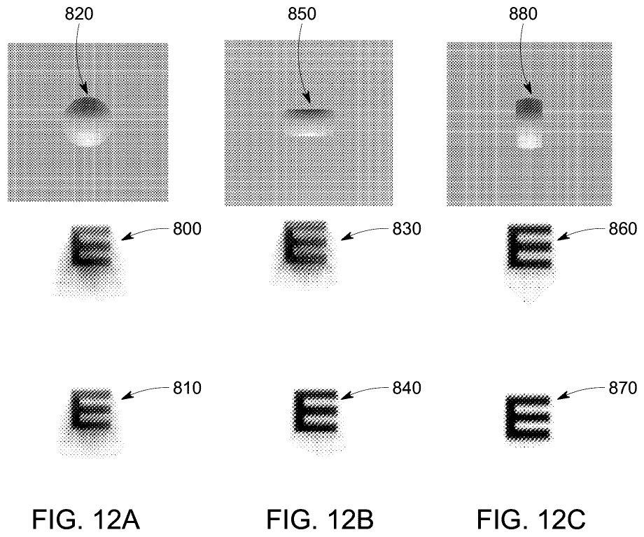

In accordance with a theoretical simulation, an aberration, vertical coma, which is the most common higher-order aberration, measured in keratoconus eyes was used to represent a highly aberrated eye. Referring generally to FIGS. 12A-12C, retinal image quality was then calculated for 3 different conditions; a typical lens without an aperture (control), a lens with horizontally oriented slotted transmissive region 850 and a lens with vertically oriented slotted transmissive region 880. Improvements in retinal image quality with both slotted transmissive regions 850, 880 were achieved compared to the control lens. The difference in retinal image quality becomes even more substantial after further correcting spherical and cylindrical refractive error induced by each lens.

It has been demonstrated that the slotted transmissive regions 850, 880 reduce the detrimental impact of an eye's aberrations on retinal image quality. FIGS. 12A-12C present images for an eye having a 6 mm pupil, moderate keratoconus, and vertical coma (Z7)=−2 micrometers (μm). FIG. 12A illustrates simulated retinal image quality for the eye provided by a lens having a 4 mm circular aperture 820 without defocus and astigmatism optimization 800 and with defocus and astigmatism optimization 810. FIG. 12B illustrates simulated retinal image quality for the eye provided by a lens having a horizontal 4×2 mm slotted transmissive region 850 without defocus and astigmatism optimization 830 and with defocus and astigmatism optimization 840. FIG. 12C illustrates simulated retinal image quality for the eye provided by a lens having a 2×4 mm vertical slotted transmissive region 880 without defocus and astigmatism optimization 860 and with defocus and astigmatism optimization 870.

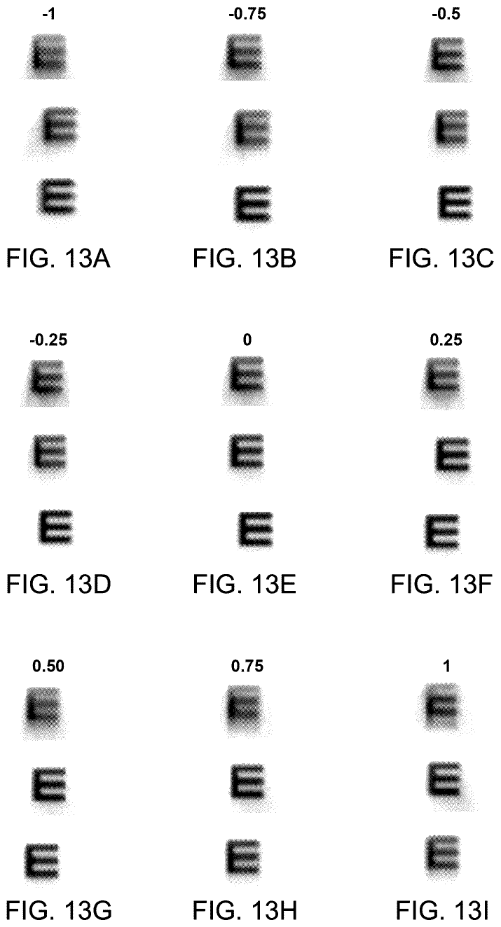

Referring generally to FIGS. 13A-13I, yet another simulation result has demonstrated that slotted transmissive regions 850, 880 also increase depth of focus compared to the conventional lens without a slotted transmissive region. FIGS. 13A-13I present images for an eye having a 6 mm pupil, moderate keratoconus, and vertical coma (Z7)=−2 μm.

Referring to FIGS. 13A-13I, a series of sets of three images of retinal image quality is presented. The top image in each set is a simulated retinal image for the eye provided by a lens having a 4 mm circular aperture. The middle image in each set is a simulated retinal image for the eye provided by a lens having a horizontal 4×2 mm slotted transmissive region 850. The bottom image in each set is a simulated retinal image for the eye provided by a lens having a 2×4 mm vertical slotted transmissive region 880.

Each set of three images is subject to an applied defocus as indicated by the number above each set given in diopters (D). Starting at FIG. 13A, the defocus is minus 1 D and increases in increments of 0.25 D ending at FIG. 13I, for which the defocus is 1 D. In this particular aberration example, as can be seen by comparison of the images in FIGS. 13A-13I, the vertically oriented slit 880 provides even better performance than the horizontally oriented slit 850 in terms of retinal image quality at each object distance as well as depth of focus.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A corrective lens for correcting aberrations of an eye of a patient, the corrective lens comprising:
a central region formed in the center of the corrective lens preventing light transmission; and
a slotted transmissive region formed in the central region, the slotted transmissive region allowing light transmission therethrough.

2. The corrective lens of claim 1, wherein the slotted transmissive region is formed in the center of the central region.

3. The corrective lens of claim 1, wherein the slotted transmissive region is formed spaced from the center of the central region.

4. The corrective lens of claim 1, wherein the lens improves depth of focus to improve retinal image quality of objects that are at far, intermediate, and near distances from the eye.

5. The corrective lens of claim 1, wherein the lens is one of a soft contact lens, hard contact lens, spectacles, and an intraocular lens.

6. The corrective lens of claim 1, wherein the corrective lens has an orientation when worn on the eye, and the slotted transmissive region is elongated in a horizontal direction relative to the orientation of the corrective lens when worn.

7. The corrective lens of claim 1, wherein the corrective lens has an orientation when worn on the eye, and the slotted transmissive region is elongated in a vertical direction relative to the orientation of the corrective lens when worn.

8. The corrective lens of claim 1, wherein the corrective lens has an orientation when worn on the eye, and the slotted transmissive region is elongated in a diagonal direction relative to the orientation of the corrective lens when worn.

9. The corrective lens of claim 1, wherein the slotted transmissive region has non-parallel long sides.

10. The corrective lens of claim 9, wherein the slotted transmissive region has curvilinear long sides.

11. The corrective lens of claim 1, wherein the central region is printed onto a surface of the corrective lens.

12. The corrective lens of claim 1, wherein the slotted transmissive region includes an aperture disposed through the corrective lens.

13. The corrective lens of claim 12, wherein the central region includes an opaque pigment in a material of the corrective lens, the aperture being formed subsequent to the opaque pigment being added.

14. The corrective lens of claim 13, wherein the aperture is formed through the corrective lens with a laser.

15. Corrective lenses for correcting aberrations of eyes of a patient, the corrective lenses comprising:
a first corrective lens and a second corrective lens;
a first central region formed in the center of the first corrective lens, the first central region preventing light transmission;
a second central region formed in the center the second corrective lens, the second central region preventing light transmission;
a first slotted transmissive region formed in the first central region, the first slotted transmissive region allowing light transmission therethrough; and
a second slotted transmissive region formed in the second central region, the second slotted transmissive region allowing light transmission therethrough.

16. The corrective lenses of claim 15, wherein the first corrective lens has a first orientation when worn on a first eye, the second corrective lens has a second orientation when worn on a second eye, the first slotted transmissive region is elongated in a first direction relative to the orientation of the first corrective lens when worn, and the second slotted transmissive region is elongated in a second direction relative to the orientation of the second corrective lens when worn, wherein the first direction is different from the second direction.

17. The corrective lenses of claim 15, wherein the first slotted transmissive region formed in the first central region has a first shape, the second slotted transmissive region formed in the second central region has a second shape, and the first shape is different from the second shape.

18. The corrective lenses of claim 15, wherein at least one of the first slotted transmissive region and the second slotted transmissive region is formed in the center of the respective first and second central regions.

19. The corrective lenses of claim 18, wherein both the first slotted transmissive region and the second slotted transmissive region are formed in the center of the respective first and second central regions.

20. A method of correcting aberrations of an eye, the method comprising positioning a corrective lens to an eye, the corrective lens having a central region formed in the center of the corrective lens, the central region preventing light transmission, and a slotted transmissive region formed in the central region allowing light transmission therethrough.
